(19) United States
(12) Patent Application Publication
(10) Pub. No.: US 2009/0301524 A1
(43) Pub. Date: Dec. 10, 2009

(54) METHOD OF REMOVING FUNGUS IN WASHING MACHINE

(75) Inventor: Hyo Joon Park, Incheon (KR)

Correspondence Address: OCCHIUTI ROHLICEK & TSAO, LLP, 10 FAWCETT STREET, CAMBRIDGE, MA, 02138, US

(73) Assignee: Daewoo Electronics Corporation, Seoul (KR)

(21) Appl. No.: 12/480,056

(22) Filed: Jun. 8, 2009

(30) Foreign Application Priority Data
Jun. 9, 2008 (KR) 10-2008-0053879

(51) Int. Cl. B08B 9/00

(52) U.S. Cl. 134/18; 134/22.1

(57) ABSTRACT

Disclosed herein is a method of removing a fungus in a washing machine. The method includes determining whether a fungus removal mode is selected, and executing the fungus removal mode if the fungus removal mode is selected.

### CROSS-REFERENCE TO RELATED APPLICATIONS

The present application claims priority to Korean patent application number 10-2008-0053879, filed on Jun. 09, 2008, which is incorporated by reference in its entirety.

### BACKGROUND OF THE INVENTION

1. Field of the Invention

The present invention relates to a method of removing a fungus in a washing machine and, more particularly, to a method of removing a fungus in a washing machine by supplying a fungicide into the washing machine to remove the fungus from a drum, a tub or laundry inside the drum.

2. Description of the Related Art

Generally, a drum washing machine performs a washing cycle by repetitiously raising and dropping laundry within a drum that rotates inside the washing machine.

Referring to FIG. 1, a drum washing machine 10 includes a cabinet 11 constituting an outer appearance of the washing machine 10, a tub 12 disposed inside the cabinet 11, a drum 13 rotatably disposed inside the tub 12, a drive unit 14 connected to the drum 13 to rotate the drum 13, and a dryer 15 for drying laundry.

A detergent container 1 is retractably inserted into the cabinet 11 and a water supply pipe 2 is connected to a water source outside the cabinet 11 to supply wash water to the detergent container 1. Detergent or fabric softener is supplied to the tub 12 through the connection pipe 3.

Conventionally, when the washing machine is used for a long time, fungi are liable to grow in the drum or the tub, thereby causing damage to the laundry. Further, when a fungus is present in contaminated laundry, it is difficult to remove the fungus from the laundry using the detergent alone.

Therefore, there is a need for solving such problems.

### SUMMARY OF THE INVENTION

The present invention is conceived to solve the problems as described above, and an aspect of the present invention is to provide a method of removing a fungus, which is present in a drum, a tub or laundry inside a washing machine.

In accordance with one aspect of the present invention, a method of removing a fungus in a washing machine includes: determining whether a fungus removal mode is selected; and executing the fungus removal mode if the fungus removal mode is selected.

The method may further include: determining whether a washing mode is selected after the fungus removal mode is executed; and executing the washing mode if the washing mode is selected.

The method may further include: detecting input of a fungicide into a fungicide container using a sensor provided to the fungicide container, if the fungus removal mode is not selected; and executing the fungus removal mode when the input of the fungicide into the fungicide container is detected.

The method may further include: determining whether the washing mode is selected after the fungus removal mode is executed; and executing the washing mode if the washing mode is selected.

### BRIEF DESCRIPTION OF THE DRAWINGS

The above and other aspects, features and advantages of the present invention will become apparent from the following detailed description in conjunction with the accompanying drawings, in which:

FIG. 1 is a sectional view of a conventional washing machine;

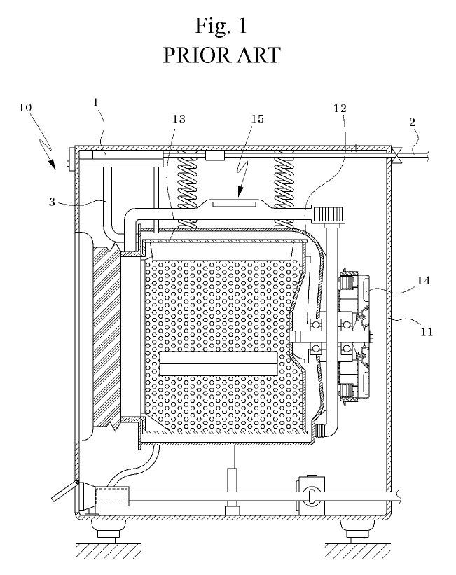

FIG. 2 is a sectional view of a washing machine according to one embodiment of the present invention; and

FIG. 3 is a flowchart of a method of removing a fungus in a washing machine according to one embodiment of the present invention.

### DETAILED DESCRIPTION OF THE INVENTION

Hereinafter, exemplary embodiments of the present invention will be described in detail with reference to the accompanying drawings. It should be noted that the drawings are not to precise scale and may be exaggerated in thickness of lines or size of components for descriptive convenience and clarity. Furthermore, the terms used herein are defined by taking functions of the present invention into account and can be changed according to the custom or intention of users or operators. Therefore, definition of the terms should be made according to the overall disclosures set forth herein.

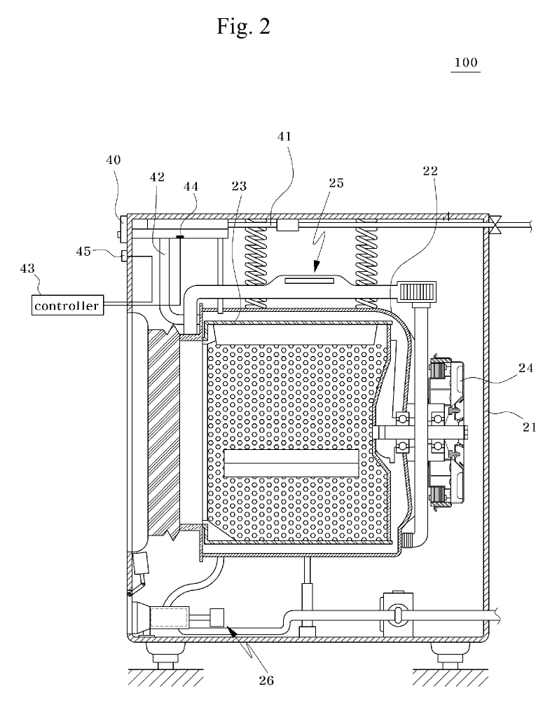

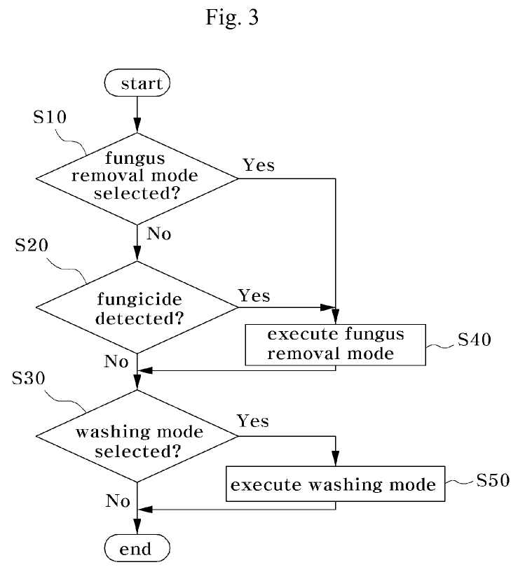

FIG. 2 is a sectional view of a washing machine according to one embodiment of the present invention, and FIG. 3 is a flowchart of a method of removing a fungus in the washing machine according to one embodiment of the present invention.

Referring to FIG. 2, a washing machine 100 includes a tub 22 in a cabinet 21 which constitutes an outer appearance of the washing machine 100. The tub 22 contains wash water and is provided therein with a drum 23 in which laundry is washed. The drum 23 is coupled to a drive unit 24 and is rotated inside the tub 22 thereby.

The washing machine 100 further includes a dryer 25 inside the cabinet 21 to dry the laundry within the drum 23. The dryer 25 includes a blower (not shown) and a heater (not shown) to dry the laundry with hot air while circulating the air in the tub 22. The tub 22 is connected to a drain unit 26 which discharges the contaminated wash water to the outside.

Further, the washing machine 100 includes a detergent container (not shown) that is retractably inserted into the cabinet 21. The detergent container contains detergent or fabric softener. The detergent container is connected to a water supply pipe, which is connected to a water source to supply wash water to the detergent container. The detergent container is also connected to a water discharge pipe (not shown) which guides the wash water from the detergent container to the tub 22.

The cabinet 21 is provided with a fungicide container 40. The fungicide container 40 receives wash water through a water supply pipe 41 and supplies the wash water to the tub 22 through a connection pipe 42. The fungicide container 40 may be provided to the detergent container. Alternatively, the fungicide container 40 may be retractably inserted into the cabinet 21.

The cabinet 21 is provided with an operation panel 45 for manipulation of the washing machine 100. The operation panel 45 includes an operation button (not shown) on which a user can select a washing mode, a fungus removal mode, and the like. A controller 43 controls respective components of the washing machine 45 to execute the washing mode or the fungus removal mode in response to a signal from the operation panel 45.

The fungicide container 40 is provided with a sensor 44. The sensor 44 detects input of a fungicide into the fungicide container 40 and informs the controller 43 of a detection result.

Next, a method of removing a fungus in the washing machine according to one embodiment of the present invention will be described with reference to FIGS. 2 and 3.

First, it is determined whether a fungus removal mode is selected through the operation panel 45 in S10. If the fungus removal mode is selected, the fungus removal mode is executed in S40, thereby removing fungi in the tub 22, the drum 23 or laundry therein.

If the fungus removal mode is not selected, it is determined whether a fungicide is input to the fungicide container 40 in S20. The fungicide container 40 is provided with the sensor 44, which detects input of the fungicide to the fungicide container 40 and sends information about the input of the fungicide to the controller 43.

When the fungicide is detected by the sensor 44 in the fungicide container 40, the fungus removal mode is executed in S40, thereby removing fungi in the tub 22, the drum 23 or the laundry therein.

After the fungus removal mode is executed (S40) through the selection of the fungus removal mode or the input of the fungicide into the fungicide container, it is determined whether a washing mode is selected through the operation panel 45 in S30. If the washing mode is selected, the washing mode is executed to perform a washing cycle in S50, and the operation of the washing machine is ended after completing the washing cycle. If the washing mode is not selected, the operation of the washing machine is ended without performing other cycles.

Further, even when the fungus removal mode is not selected or even when the fungicide is not input to the fungicide container 40, it is determined whether the washing mode is selected through the operation panel 45 in S30. If the washing mode is selected, the washing mode is executed to perform a washing cycle in S50, and the operation of the washing machine is ended after completion of the washing cycle. If the washing mode is not selected, the operation of the washing machine is ended without performing other cycles.

As apparent from the above description, according to one embodiment of the invention, the method can remove fungi in the drum or tub of the washing machine, thereby preventing the fungi from contaminating laundry in the washing machine.

Further, the method can remove fungi from the laundry in the washing machine, thereby improving washing efficiency.

Although some embodiments have been provided to illustrate the present invention in conjunction with the accompanying drawings, it will be apparent to those skilled in the art that the embodiments are given by way of illustration only, and that various modifications and equivalent embodiments can be made without departing from the spirit and scope of the present invention. Further, the description of the drum type washing machine as provided herein is only one example of the present invention, and the present invention can be applied to other devices. Accordingly, the scope and spirit of the present invention should be limited only by the following claims.

What is claimed is:

1. A method of removing a fungus in a washing machine, comprising:
determining whether a fungus removal mode is selected; and
executing the fungus removal mode if the fungus removal mode is selected.

2. The method according to claim 1, further comprising:
determining whether a washing mode is selected after the fungus removal mode is executed; and
executing the washing mode if the washing mode is selected.

3. The method according to claim 1, further comprising:
detecting input of a fungicide into a fungicide container using a sensor provided to the fungicide container, if the fungus removal mode is not selected; and
executing the fungus removal mode when the input of the fungicide into the fungicide container is detected.

4. The method according to claim 3, further comprising:
determining whether the washing mode is selected after the fungus removal mode is executed; and
executing the washing mode if the washing mode is selected.
